(19) United States
(12) Patent Application Publication
(10) Pub. No.: US 2015/0019300 A1
(43) Pub. Date: Jan. 15, 2015

(54) ECONOMIC PERFORMANCE METRIC BASED VALUATION

(71) Applicant: Uber Cog LLC, Kirkland, WA (US)

(72) Inventors: Sidney Carl Porter, Kirkland, WA (US); Swain W. Porter, Kirkland, WA (US)

(21) Appl. No.: 13/939,882

(22) Filed: Jul. 11, 2013

(51) Int. Cl. G06Q 10/06

(52) U.S. Cl. CPC G06Q 10/06393; G06Q 40/06
USPC 705/7.39; 705/36 R

(57) ABSTRACT

Apparatuses, methods and storage medium associated with determining valuation(s) for one or more companies are disclosed herein. In embodiments, a method for computing valuation of a company may include filtering out outlying ones of a plurality of valuations and a plurality of objectively measurable economic performance metric values of a plurality of other companies. The method may further include computing value driver model parameters and risk ratio model parameters of a valuation model, and outputting the model parameters of the valuation model to a modeler for use to compute an economic performance metric values based valuation of a company. Other embodiments may be described and claimed.

### TECHNICAL FIELD

The present disclosure relates to the field of data processing, in particular, to apparatuses, methods and storage medium associated with determining a valuation of one or more companies, based on economic performance metric values.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Traditional valuation of companies often involve employment of subject factors such as strategic value, market momentum, market sentiment, synergistic potentials, and so forth. As a result, traditional valuation has been inconsistent and unreliable.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of a computing arrangement incorporated with the teachings of the present disclosure for computing valuation for one or more companies, in accordance with various embodiments.

FIGS. 2-4 illustrate an example process for determining model parameters of a valuation model, in accordance with various embodiments.

FIG. 5 illustrates an example process for determining valuation for one or more companies based on economic value metric values, in accordance with various embodiments.

FIG. 6 illustrates an example computing environment suitable for practicing the present disclosure, in accordance with various embodiments.

FIG. 7 illustrates an example storage medium with instructions configured to enable an apparatus to practice various aspects of the present disclosure, in accordance with various embodiments.

### DETAILED DESCRIPTION

Apparatuses, methods and storage medium associated with determining valuation(s) for one or more companies, based on economic performance metric values, are disclosed herein. In embodiments, a method for determining valuation of a company may include ingesting, by a computing device, a plurality of valuations and a plurality of objectively measurable economic performance metric values of a plurality of other companies, and filtering out outlying ones of the valuations or the economic performance metric values of the other companies. The method may further include computing value driver model parameters and risk ratio model parameters of a valuation model; and outputting the model parameters of the valuation model to a modeler to user to compute an economic performance metric values based valuation of a company.

In embodiments, an apparatus, e.g., a smartphone or a computing tablet, may include one or more processors, and storage medium having an analyzer and/or a modeler configured to cause the apparatus, in response to operation by the one or more processors, to perform various aspects of the above described methods and their variants.

In embodiments, at least one storage medium may include instructions configured to cause an apparatus, in response to execution by the apparatus, to perform various aspects of the above described methods and their variants.

In the detailed description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality. The term “closed captions” is to include traditional closed captions and/or subtitles.

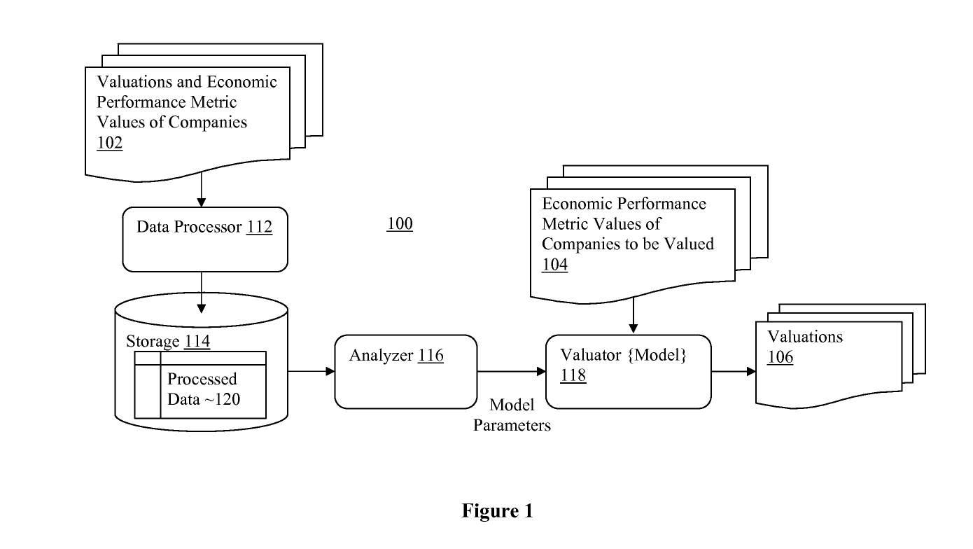

Referring now FIG. 1, an overview of an example computing arrangement incorporated with the teachings of the present disclosure for computing valuation(s) for one or more companies, in accordance with various embodiments, is shown. As illustrated, in embodiments, computing arrangement 100 may include data processor 112, analyzer 116, and modeler 118, operatively coupled with each other as shown.

Data processor 112, in embodiments, may be configured to ingest valuations and economic performance metric values of companies, in different formats and store them in a common format for analyzer 116. Economic performance metric values may include but not limited to revenues, sales, earnings before interest, tax, deduction and amortization (EBITDA), earnings before interest and tax (EBIT), gross profits, net profits, net incomes, operating income before interest, tax, deduction and amortization (OBITDA), operating income before interest, deduction and amortization (OBIDA), operating margin, cash, inventory, accounts receivable and other assets, accounts payable, short and long-term debt and other non-debt liabilities, company age, book values and other relevant financial information. In embodiments, economic performance metric values of hundreds or thousands of companies of different industries and/or sectors are ingested.

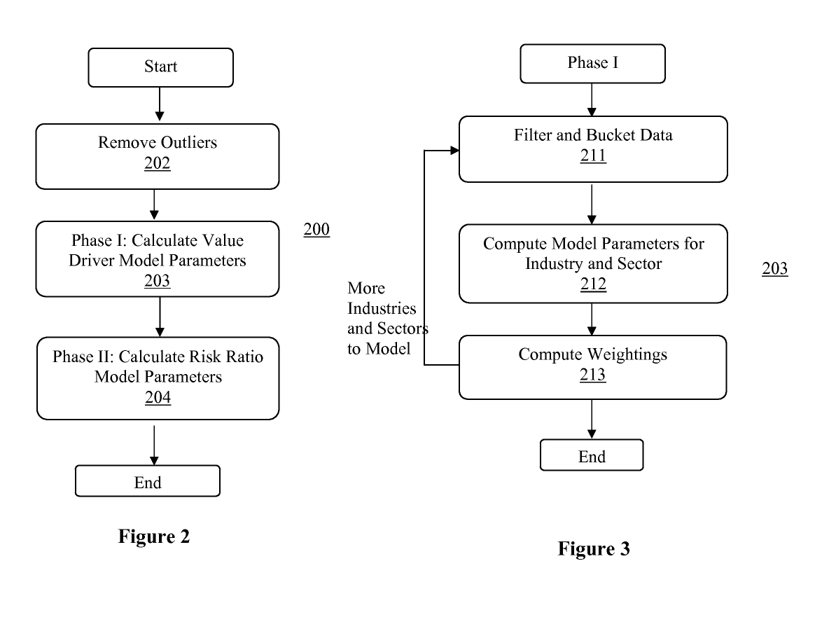

Analyzer 116, in embodiments, may be configured to analyze the data as further described in FIGS. 2-4. In embodiments, special techniques, known in Robust Statistics as bootstrapping and shrinkage, may be combined with the process described in these figures when a sector or industry data set is relatively small.

In embodiments, the pre-processors 112 and the analyzer 116 may be disposed on a first computing device, whereas the modeler 118 may be operated by a second computing device, using the model parameters, and economic performance metric values of the company, to compute the economic performance metric based valuation of the company.

FIGS. 2-3 illustrate the analysis process of analyzer 116, including computations performed, in accordance with various embodiments of the present disclosure. In embodiments, analysis process 200 may start with remove outliers (202), which may implement outlier detection and exclusion of the data ingested by data processor 112. Recall data processor 112 may be configured to collect data from multiple sources, perform conversions, scaling and reformatting of the collected data to common formats and data specifications, perform checks to automatically identify and clean input and conversion errors. Conversion may include converting all valuations and economic performance metric values to concentrate around respective centers of the valuations and the economic performance metric values. Scaling the valuations and the economic performance metric values of the other companies may include respectively applying scaling factors to the valuations and the economic performance metric values. Transforming the valuations and the economic performance metric values of the other companies may include respective non-linear conversions of the valuations and the economic performance metric values.

During removal of outliers (202), filtering out outlying ones of the valuations or the economic performance metric values of the other companies may include identifying and removing outlying ones of the valuations or the economic performance metric values of the other companies, by respectively comparing the valuations or the economic performance metric values of the other companies to both empirical and modeled distributions of the valuations or the economic performance metric values of the other companies.

Filtering out outlying ones of the valuations or the economic performance metric values of the other companies may also include identifying and removing outlying ones of the valuations or the economic performance metric values of the other companies, by applying a combination of Peirce's criterion, and a modification Dixon's Q test and scatter entropy (a measure of dispersion created by the inventor and not yet published) to the valuations or the economic performance metric values of the other companies.

From removing outliers operation (202), analysis process 200 may proceed to Phase I calculate value driver model parameters (203), where value driver model parameters of the valuation models may be calculated. Examples of value driver model parameters may include filtering parameters, outlier exclusion parameters, regression coefficients, industry specific weightings, similarity measures, dispersion measures, and tuning parameters. Value driver model parameters calculation (203) will be now described with references to FIG. 3.

Referring now to FIG. 3, value driver model parameters calculation (203) may start with Filter and Bucket Data (211), which may involve transforming and then centering the data, aggregating the data from multiple perspectives, applying filters designed to maximize the signal to noise ratio, where the term signal refers to the contribution to market value of factors modeled by the system while noise refers to the impact of factors not modeled upon market value.

Thereafter, value driver model parameters calculation (203) may then proceed to compute model parameters for the valuation models of the various industries or sections (212). In embodiments, the valuation model may include an implicitly defined function configured to yield the valuation of the company based on a self-reference relationship, e.g., between the function of the value and its relationship to the plurality of economic performance metric values of the company. The model parameters may comprise parameters of the implicitly defined function. The implicit function theorem allows the derivative of the resulting function to be calculated. In turn, optimizers based on e.g., the Newton-Raephson or other methods can be applied to solve for the initial valuation estimate.

From model parameter computation for various industries/sectors (212), value driver model parameters calculation (203) may proceed to calculate weighting (213) to tune each parameter, industry and sector. In some embodiments, scatter entropy and techniques from the field of robust statistics may be used calculate weightings.

Referring back to FIG. 2, the output of Phase I may be used in Phase II—calculation of risk ratio model parameters (204), to compute the impact of risk factors and financial ratios upon the valuation, which is further illustrated in FIG. 4. Examples of risk ratio model parameters may include factor loadings, regression coefficients, industry specific weightings, similarity coefficients, dispersion measures, tuning parameters principle component analysis, and comparable selection (choosing most influential parameters).

Referring now to FIG. 4, Phase II—calculation of risk ratio model parameters (204) may start with using parameters output by Phase I to pre-estimate the economic performance metric values based valuations and compute residuals (221). Residuals may be computed by subtracting the Phase I price estimates from the actual transaction prices. The residuals may then be filtered, centered, transformed and preprocessed to prepare them for further analysis.

From pre-estimate the economic performance metric values based valuations and compute residuals (221), Phase II (204) may proceed to Principal Component Analysis (222), where Factor Analysis may be performed on key ratios and risk factors for purposes of dimension reduction to reduce computing time, to orthogonalize data to reduce sensitivity to noise and to improve the explanatory power of the model.

From Principal Component Analysis (222), Phase II (204) may proceed to Regress Residuals (223), where residuals are regressed against the factors and/or principal components using methods from Robust Statistics. The preliminary model estimate may then be further refined based on risk factor loadings.

From Regress Residuals (223), Phase II (204) may proceed to Optimize Tuning Parameters (224), where the parameters may be optimized by adjusting them and re-estimated until an exit criterion is reached. An example of an exit criterion may be incremental fit improvement falling below a threshold at the end of a Phase. The model parameters may then be stored, and the process may be repeated for the remainder of industries and sectors.

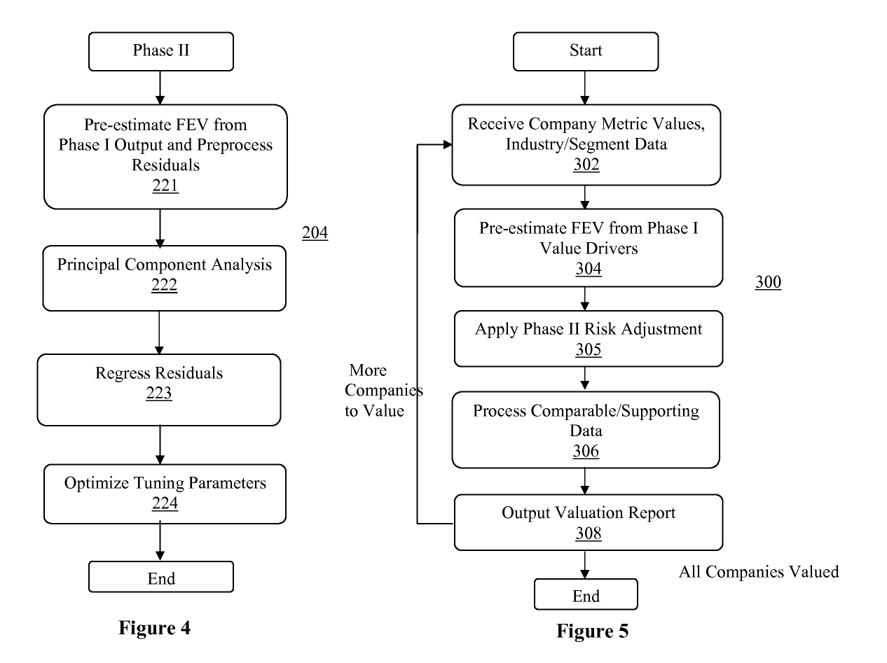

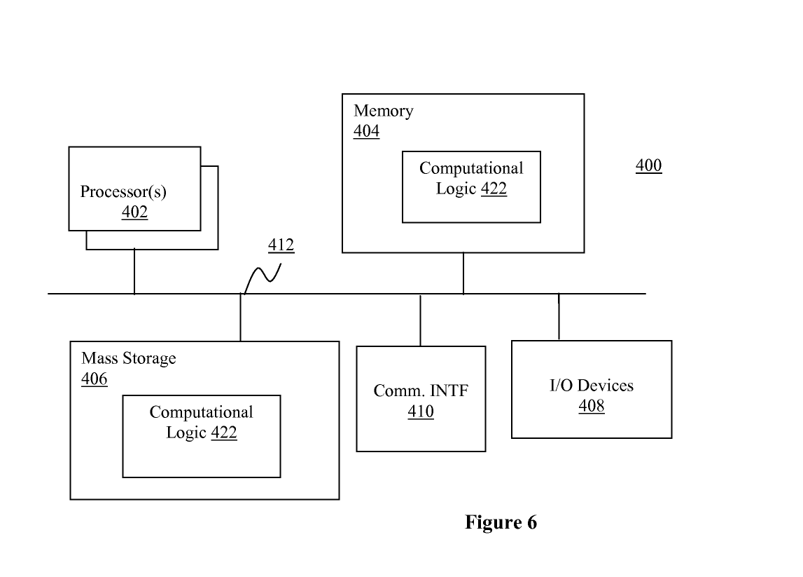

Referring now to FIG. 5, wherein a process for creating a Economic Performance Metric Based Valuation Report, in accordance with various embodiments, is illustrated. Process 300 may be performed, e.g., by Valuator (Model) 118, operating on a computing device, e.g., computing device 400 of FIG. 6.

Process 300 may start with the computer system receiving company metrics (302), industry and sector information and/or other relevant information. These metrics may be preprocessed, transformed and centered to prepare them for further processing.

From 302, process 300 may proceed to having the system pre-estimates an initial valuation (304) from Value Drivers using Phase I parameters and tuning parameters calculated and stored, as earlier described. In some embodiments, preliminary stages using these parameters may be preprocessed and stored to improve system response times.

In embodiments, the calculation may include solving an implicitly defined function with a 2-stage optimizer based on the Newton-Raephson or other methods, with guaranteed convergence.

From 302, process 300 may proceed to have the system apply risk and ratio adjustments (305) to the valuation using factor loadings computed and stored by Phase II, as earlier described, to calculate the final valuation estimate.

From 305, for some embodiments, process 300 may proceed to have comparable and supporting data (306) gathered and computed by the system to provide supporting documentation for the valuation report. Estimation, interpolation and smoothing techniques from the field Robust Statistics may be used to perform the calculations.

With or without performing 306, process 300 may proceed to have the system compile an Economic Performance Metric Based Valuation Report (308), which provide the economic performance metric based valuation. In embodiments, the report may include input parameters, supporting data, charts and graphs calculated, along with other descriptions and information.

Referring now to FIG. 6, wherein an example computer suitable for use for the arrangement of FIG. 1, in accordance with various embodiments, is illustrated. As shown, computer 400 may include one or more processors or processor cores 402, and system memory 404. For the purpose of this application, including the claims, the terms “processor” and “processor cores” may be considered synonymous, unless the context clearly requires otherwise. Additionally, computer 400 may include mass storage devices 406 (such as diskette, hard drive, compact disc read only memory (CD-ROM) and so forth), input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage devices 406 may be employed to store a working copy and a permanent copy of the programming instructions implementing the operations associated with Analyzer 116 of FIG. 1, earlier described, collectively denoted as computational logic 422. The various elements may be implemented by assembler instructions supported by processor(s) 402 or high-level languages, such as, for example, C or R, that can be compiled into such instructions.

The permanent copy of the programming instructions may be placed into permanent storage devices 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The number, capability and/or capacity of these elements 410-412 may vary, depending on the intended use of example computer 400, e.g., whether example computer 400 is a stationary computing device like a set-top box or a desktop computer, or a mobile computing device, like a smartphone, tablet, netbook, or laptop. The constitutions of these elements 410-412 are otherwise known, and accordingly will not be further described.

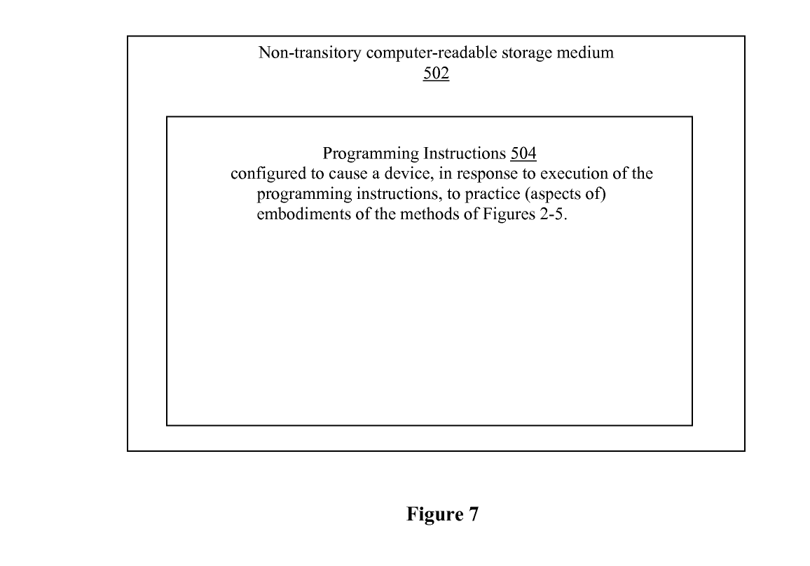

FIG. 7 illustrates an example non-transitory computer-readable storage medium having instructions configured to practice all or selected ones of the operations associated with Analyzer 116 and Modeler 118 of FIG. 1, earlier described; in accordance with various embodiments. As illustrated, non-transitory computer-readable storage medium 502 may include a number of programming instructions 504. Programming instructions 504 may be configured to enable a device, e.g., computer 400, in response to execution of the programming instructions, to perform, e.g., various operations of processes 200 and/or 300 of FIGS. 2-5. In alternate embodiments, programming instructions 504 may be disposed on multiple non-transitory computer-readable storage media 502 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method for determining a valuation for a company, comprising:
filtering out, by the computing device, outlying ones of a plurality of valuations and a plurality of objectively measurable economic performance metric values of a plurality of other companies;
computing, by the computing device, a plurality of value driver model parameters of a valuation model, based at least in part on remaining ones of the valuations and the economic performance metric values;
computing, by the computing device, a plurality of risk ratio model parameters of the valuation model, based at least in part on the value driver model parameters; and
outputting the value driver model parameters and the risk ratio model parameters of the valuation model, by the computing device, to a modeler configured to compute the valuation of a company based on objectively measurable economic performance metric values of the company, using the valuation model.

2. The method of claim 1, wherein the plurality of economic performance metric values comprise values of at least two selected ones of revenues, sales, earnings before interest, tax, deduction and amortization (EBITDA), earnings before interest and tax (EBIT), gross profits, net profits, net incomes, operating income before interest, tax, deduction and amortization (OBITDA), operating income before interest, deduction and amortization (OBIDA), operating margin, cash, inventory, accounts receivable, accounts payable, short and long-term debt, other non-debt liabilities, company age, or book values.

3. The method of claim 1, wherein filtering out outlying ones of the valuations or the economic performance metric values of the other companies comprises identifying and removing outlying ones of the valuations or the economic performance metric values of the other companies, by respectively comparing the valuations or the economic performance metric values of the other companies to average or standard deviations of the valuations or the economic performance metric values of the other companies.

4. The method of claim 1, wherein filtering out outlying ones of the valuations or the economic performance metric values of the other companies comprises identifying and removing outlying ones of the valuations or the economic performance metric values of the other companies, by applying at least one of Peirce's criterion, scatter entropy, Grubb's test or Dixon's Q test to the valuations or the economic performance metric values of the other companies.

5. The method of claim 1, wherein computing a plurality of value driver model parameters of a valuation model comprises:
filtering and bucketing, by the computing device, the valuations and the economic performance metric values of the other companies;
computing, by the computing device, the value driver model parameters of the valuation model for a plurality of industries or sectors; and
calculating, by the computing device, a plurality of weights to tune the value driver model parameters.

6. The method of claim 5, wherein filtering and bucketing comprises transforming and centering the valuations and the economic performance metric values of the other companies, aggregating the valuations and the economic performance metric values of the other companies from multiple perspectives, or applying filters designed to increase signal to noise ratio.

7. The method of claim 1, wherein the valuation model comprises an implicit function configured to yield the valuation of the company based on a self-referencing relationship between the value and the plurality of economic performance metric values of the company, wherein the model parameters comprise parameters of the function.

8. The method of claim 1, wherein computing a plurality of risk ratio model parameters of the valuation model comprises:
pre-estimating, by the computing device, economic performance metric values based valuations, and residuals;
performing principal component analysis, by the computing device, on a plurality of ratios and factors; and
regressing, by the computing device, the residuals against the factors.

9. The method of claim 8, wherein computing a plurality of risk ratio model parameters of the valuation model further comprises optimizing the parameters.

10. The method of claim 1, wherein the computing device comprises a first computing device, and wherein the method further comprises operating the valuation model, by a second computing device, using the value driver and risk ratio model parameters, and economic performance metric values of the company, to compute the valuation of the company.

11. The method of claim 10, wherein operating the valuation model comprises:
receiving, by the second computing device, economic performance metric values of the company;
estimating, by the second computing device, an initial economic performance metric based valuation, based at least in part on the value driver model parameters;
applying, by the second computing device, risk ratio adjustments to the initial economic performance metric based valuation to generate an adjusted economic performance metric based valuation; and
outputting, by the second computing device, the adjusted economic performance metric based valuation.

12. The method of claim 11, wherein operating the valuation model further comprises gathering comparable data, and outputting further comprises outputting the comparable data to accompany the adjusted economic performance metric based valuation.

13. The method of claim 10, wherein the first and the second computing device are the same computing device.

14. The method of claim 1, wherein the other companies comprise public or private companies.

15. The method of claim 1, wherein the computing is performed to determine a purchase or sale price, a credit risk, or a credit rating of the company.

16. An apparatus for determining a valuation of a company, comprising
one or more processors; and
storage medium coupled to the one or more processors, and having an analyzer configured to cause the apparatus, in response operation of the analyzer by the one or more processors, to perform the method of claim 1.

17. The apparatus of claim 16, wherein the storage medium further comprises a modeler configured to cause the apparatus, in response operation of the modeler by the one or more processors, to:
receive economic performance metric values of the company;
estimate an initial economic performance metric based valuation, based at least in part on the value driver model parameters;
apply risk ratio adjustments to the initial economic performance metric based valuation to generate an adjusted economic performance metric based valuation; and
output the adjusted economic performance metric based valuation.

18. The apparatus of claim 17, wherein the storage medium further comprises a selected one of a decision making application, comprising the modeler.

19. At least one storage medium comprising a plurality of instructions configured to cause an apparatus, in response to execution of the instructions by the apparatus, to perform the method of claim 1.

20. The storage medium of claim 19, wherein the instructions, in response to execution by the apparatus, further cause the apparatus to:
receive economic performance metric values of the company;
estimate an initial economic performance metric based valuation, based at least in part on the value driver model parameters;
apply risk ratio adjustments to the initial economic performance metric based valuation to generate an adjusted economic performance metric based valuation; and
output the adjusted economic performance metric based valuation.

21. A method for computing a valuation for a portfolio having a first plurality of companies, comprising:
filtering out, by the first computing device, outlying ones of a plurality of valuations and a plurality of objectively measurable economic performance metric values of a second plurality of companies;
computing, by the computing device, a plurality of value driver model parameters of a valuation model, based at least in part on remaining ones of the valuations and the economic performance metric values;
computing, by the computing device, a plurality of risk ratio model parameters of the valuation model, based at least in part on the value driver model parameters;
operating the valuation model, with a second computing device, using the value driver and risk ratio model parameters, and economic performance metrics of the first plurality of companies to compute valuations of the first plurality of companies; and
calculating the valuation of the portfolio, by the second computing device, based at least in part on the valuations of the first plurality of companies.

22. The method of claim 21, wherein the first and second computing devices are the same computing device.

23. The method of claim 21, wherein calculating the valuation of the portfolio comprises summing, by the second computing device, the valuations of the first plurality of companies.

24. The method of claim 21, wherein the portfolio is held by a commercial bank, an investment bank, a mutual fund, a hedge fund, or an institutional investor.

25. An apparatus for computing a valuation of a company, comprising
one or more processors; and
storage medium coupled to the one or more processors, and having an analyzer and a modeler configured to cause the apparatus, in response operation of the analyzer and the modeler by the one or more processors, to perform the method of claim 21.

26. The apparatus of claim 25, wherein the storage medium further comprises a selected one of a decision making application, comprising the modeler.

27. At least one storage medium comprising a plurality of instructions configured to cause an apparatus, in response to execution of the instructions by the apparatus, to perform one of the method of claim 21.
